(19) United States
(12) Patent Application Publication
(10) Pub. No.: US 2014/0144597 A1
(43) Pub. Date: May 29, 2014

(54) Protective barrier

(71) Applicant: Services de Forage Orbit Garant Inc., Val-d'Or (CA)

(72) Inventors: Robert Collard, Authier-Nord (CA); Mario Boisvert, Barraute (CA)

(21) Appl. No.: 13/907,152

(22) Filed: May 31, 2013

Related U.S. Application Data
(60) Provisional application No. 61/729,767, filed on Nov. 26, 2012.

(51) Int. Cl. E05D 15/06

(52) U.S. Cl. CPC E05D 15/0652
USPC 160/197; 160/196.1

(57) ABSTRACT

A protective barrier, the protective barrier comprising: a substantially elongated beam; a beam support for supporting the beam and allowing longitudinal movements of the beam relative thereto; and a protective element mounted to the beam and configurable between a protective element extended configuration and a protective element retracted configuration, wherein the protective element extends along a larger portion of the beam in the protective element extended configuration than in the protective element retracted configuration.

### FIELD OF THE INVENTION

The present invention relates generally to the field of safety. More specifically, the present invention is concerned with a protective barrier.

### BACKGROUND OF THE INVENTION

Machinery often requires to be protected so that users of the machinery do not contact moving elements, which could result in injury or even death. For example, in the drilling industry, it is required that drilling equipment be protected in this manner. However, currently existing protecting equipment typically do not provide easy access to the drilling equipment as they only includes relatively small access doors. This is problematic as, for example, there is a need to regularly add new drilling rods to the drilling equipment. Since these rods are typically relatively long and relatively heavy, this puts great physical strain on the operator of the drilling equipment who has to insert these rods through the access doors.

Against this background, there exists a need in the industry to provide an improved protective barrier.

An object of the present invention is therefore to provide an improved protective barrier.

### SUMMARY OF THE INVENTION

In a broad aspect, the invention provides a protective barrier, the protective barrier comprising: a substantially elongated beam defining substantially longitudinally opposed beam first and second ends; a beam support supporting the beam, the beam being substantially longitudinally movable relative to the beam support between a beam extended configuration and a beam retracted configuration, the beam first end being closer to the beam support in the beam retracted configuration than in the beam extended configuration; and a protective element mounted to the beam and configurable between a protective element extended configuration and a protective element retracted configuration, the protective element defining substantially opposed protective element first and second ends. The protective element extends along a larger portion of the beam in the protective element extended configuration than in the protective element retracted configuration so that the protective element first and second ends are closer to each other in the protective element retracted configuration than in the protective element extended configuration.

For the purpose of this document, the term “beam” means any elongated structure of transversal dimensions that are smaller, and typically much smaller, than the length of the beam. The beam is substantially rigid so as to not bend significantly under the weight of the protective element. In some embodiments of the invention, the beam is hollow, but in alternative embodiments, the beam has any other suitable shape.

The protective element is any element that may prevent access to elements located beyond the protective element. In some embodiments, the protective element is also able to bloc debris projected by a piece of machinery located behind the protective element. As such, the protective element may include a mesh of suitable dimensions or may fill completely a region of space.

In some embodiments of the invention, the protective element is provided between the beam first end and the beam support, the beam support preventing movements of the protective element second end towards the beam second end beyond a predetermined location. For example, the beam support prevents movements of the protective element second end towards the beam second end beyond the beam support.

In some embodiments of the invention, the protective element is mounted to the beam so that the protective element first end and the beam first end remain substantially fixed relative to each other when the protective element is moved between the protective element extended and retracted configurations.

Furthermore, in some embodiments of the invention, the protective element is operatively coupled to the beam support, for example by being attached thereto, so that the protective element second end and the beam support remain substantially fixed relative to each other when the beam is moved between the beam extended and retracted configurations.

In some embodiments of the invention, the beam support defines a beam support passageway, the beam being partially inserted in the beam support passageway. In some embodiments of the invention, the beam support is provided with beam support rollers protruding at least partially in the beam support passageway for guiding movements of the beam in the beam passageway. For example, the beam support rollers include beam support horizontal rollers at least partially supporting the beam or beam support vertical rollers at least partially guiding lateral movements of the beam or a combination of both beam support horizontal and vertical rollers.

In some embodiments of the invention, the beam defines a beam outer surface and a beam passageway both extending substantially longitudinally therealong, a substantially longitudinally extending slit extending between the beam outer surface and the beam passageway, the protective barrier further comprising protective element supports secured to the protective element and mounted through the slit, the protective element supports having a portion thereof that is larger than a width of the slit and mounted in the beam passageway. For example, the slit is provided on an underside of the beam so that the protective element is suspended from the beam. Typically, in this example, the protective element supports each include at least one wheel rollable along the beam inside the beam passageway when mounted thereinto.

In some embodiments of the invention, an end element extends from the beam substantially adjacent the beam first end. In some embodiments of the invention, the end element is provided with a handle. In some embodiments of the invention, the protective element first end is substantially adjacent the end element. In some embodiments of the invention, the end element extends substantially perpendicular to the beam.

In some embodiments of the invention, the protective element includes a canvas. In some embodiments of the invention, the protective element is an accordion protective element including a series of panels extending along the beam and serially hinged to each other, the series of panels being foldable together.

In some embodiments of the invention, the protective barrier includes a proximity sensor part of an interlock system couplable to a piece of machinery for preventing operation of the piece of machinery when the beam is moved away from the beam extended configuration.

Advantageously, the proposed protective barrier is manufacturable using known components and methods at a relatively low cost while being of sturdy construction. Retraction of the beam when the protective element is retracted provides good access to elements protected by the protective barrier as such access is unimpeded. Also, the proposed protective barrier is relatively easy to use.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates a protective barrier in accordance with an embodiment of the present invention;

FIG. 2, in a perspective exploded view, illustrates the protective barrier shown in FIG. 1;

FIG. 3, in a front elevation view with parts removed, illustrates the protective barrier shown in FIGS. 1 and 2;

FIG. 4, in a side cross-sectional view taken along section line C-C of FIG. 3, illustrates the protective barrier shown in FIGS. 1 to 3;

FIG. 5, in a partial front cross-sectional view taken along section line D-D of FIG. 4, illustrates a beam part of the protective barrier shown in FIGS. 1 to 4;

FIG. 6, in a perspective exploded view, illustrates a beam support part of the protective barrier shown in FIGS. 1 to 4;

FIG. 7, in a side elevation view, illustrates a protective barrier in accordance with an alternative embodiment of the present invention, the protective barrier being shown with a protective element thereof in a protective element extended configuration;

FIG. 8, in a side elevation view, illustrates the protective barrier shown in FIG. 7, the protective barrier being shown with the protective element in a protective element retracted configuration;

FIG. 9, in a perspective exploded view, illustrates the protective barrier shown in FIGS. 7 and 8; and

FIG. 10, in a perspective view with parts removed, illustrates the protective barrier shown in FIGS. 7 to 9, the protective barrier being shown with the protective element thereof in a partially retracted configuration, only part of the protective element being shown.

### DETAILED DESCRIPTION

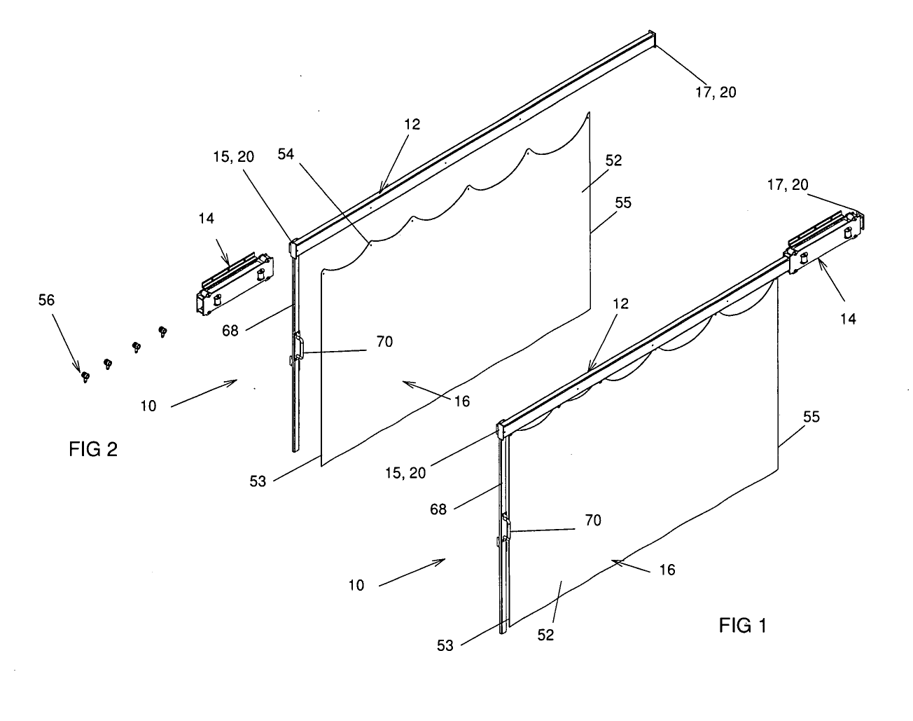

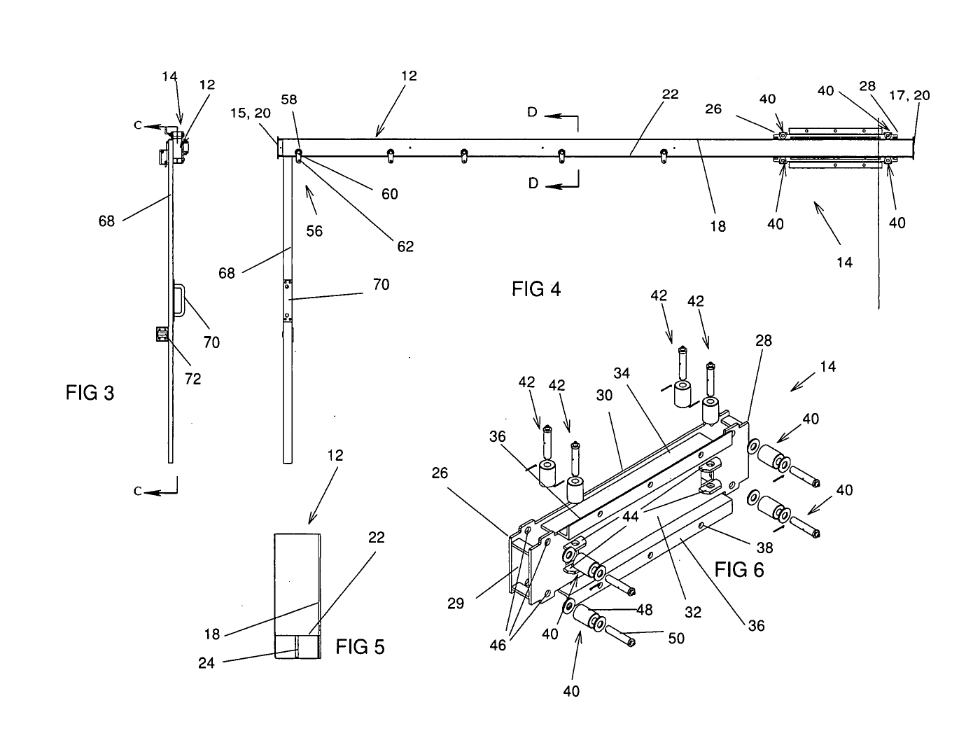

Referring to FIGS. 1 and 2, there is shown a protective barrier 10 in accordance with an embodiment of the present invention. The protective barrier 10 includes a beam 12, a beam support 14 and a protective element 16. The beam 12 is typically substantially elongated. The beam support 14 supports the beam 12. The beam 12 is substantially longitudinally movable relative to the beam support 14 between a beam extended configuration (seen for example in FIG. 1) and a beam retracted configuration, the beam retracted configuration being shown in FIG. 8 for an alternative protective barrier 10′ described in further details hereinbelow. The protective element 16 is mounted to the beam 12 and configurable between a protective element extended configuration (seen for example in FIG. 1) and a protective element retracted configuration, the protective element retracted configuration being shown in FIG. 8 for the alternative protective barrier 10′. The protective element 16 extends along a larger portion of the beam 12 in the protective element extended configuration than in the protective element retracted configuration.

A typical use of the protective barrier 10 is to protect users of machinery, for example drilling equipment, from moving parts of the machinery, which could result in an injury or even death of the user. For example, a protective enclosure, not shown in the drawings, is built around the machinery, and a segment of the perimeter thereof is left unoccupied by the protective enclosure. The protective barrier 10 is mounted adjacent this unoccupied portion and is used to provide selective access to the machinery. However, the protective barrier 10 is usable in any other suitable manner.

As seen in FIGS. 4 and 5, the beam 12 is typically hollow, but other configurations, such as for example an I-shaped beam, are within the scope of the invention. Referring to FIG. 4, the beam 12 defines a beam first end 15 and a substantially longitudinally opposed beam second end 17. The beam first end 15 is closer to the beam support 14 in the beam retracted configuration than in the beam extended configuration. A beam passageway 18 extends along the beam 12, the beam passageway 18 being closed adjacent the beam first and second ends 15 and 17 by beam end plates 20. Typically, the beam 12 has a substantially rectangular transversal cross-sectional configuration and defines a roller supporting surface 22 inside the beam passageway 18 on the bottom thereof. However, other configurations of the beam 12 are possible. The roller supporting surface 22 is provided with a slit 24 (seen in FIG. 5) extending therethrough and extending along the beam 12. More generally, in some embodiments of the invention, the beam 12 defines a beam outer surface 21 extending substantially longitudinally therealong and a substantially longitudinally extending slit 24 extends between the beam outer surface 21 and the beam passageway 18. In the embodiment of the invention shown in the drawings, the slit 24 is provided on an underside of the beam 12 so that the protective element 16 is suspended from the beam 12.

Referring to FIG. 6, the beam support 14 is substantially elongated and defines opposed beam support first and second ends 26 and 28 and a beam support passageway 29 extending therebetween. However, other types of beam support are within the scope of the invention, such as U-shaped transversal configuration beam supports, among other possibilities. The beam support 14 is typically shorter than the beam 12, but in some embodiments, the beam support 14 and the beam 12 have similar lengths, or the beam support 14 is longer than the beam 12. The beam 12 is partially inserted in the beam support passageway 29.

The beam support 14 includes first and second side plates 30 and 32 extending between the beam support first and second ends 26 and 28. Connecting plates 34 extend between the first and second side plates 30 and 32, typically adjacent the upper and lower ends thereof. FIG. 6 only shows one connecting plate 34. The first and second side plates 30 and 32 are connected to each other through the connecting plates 34. In alternative embodiments of the invention, the beam support 14 is any other suitable elongated hollow, or not hollow structure.

The beam support 14 is typically mountable to a sturdy structure adjacent the protective barrier 10. To that effect, one of the first and second side plates 30 and 32, in the drawings the second side plate 32, is provided with mounting brackets 36. For example, the mounting brackets 36 are substantially L-shaped and extend outwardly laterally from the second side plate 32. Typically, brackets apertures 38 are provided along the mounting brackets 36 for inserting thereinto a suitable fastener (not shown in the drawings) for attaching the beam support 14 to the sturdy structure.

Beam support horizontal rollers 40 and beam support vertical rollers 42 are provided for facilitating and guiding movements of the beam 12 along the beam support 14. To that effect, the beam support horizontal and vertical rollers 40 and 42 are rotatably mounted to the remainder of the beam support 14 and each have a part thereof that protrudes in the beam support passageway 29. However, in alternative embodiments of the invention, only beam support vertical rollers 42, only beam support horizontal rollers 40 or no rollers are provided. Also, in yet other embodiments of the invention not shown in the drawings, the beam support 14 includes bearings for mounting the beam 12 thereto.

For example, the beam support horizontal and vertical rollers 40 and 42 each include a cylinder 48 mounted for rotatable motion about an axle 50. Roller receiving apertures 46 are provided in the first and second side plates 30 and 32, for example adjacent the beam support first and second ends 26 and 28 and adjacent the connecting plates 34, such that each of the beam support horizontal rollers 40 has its cylinder 48 received between the first and second side plates 30 and 32, generally horizontally, with the axle 50 thereof inserted through the roller receiving apertures 46. Also, the first and second side plates 30 and 32 each include two pairs of roller mounting flanges 44, each extending generally laterally outwardly and horizontally from the first and second side plates 30 and 32. The roller mounting flanges 44 pairwise receive a cylinder 48 therebetween, generally vertically oriented, and are used to mount a respective axle 50 thereto.

The beam 12 is mounted to the beam support 14 through the beam support passageway 29 so as to be supported by the beam support horizontal rollers 40 and to be laterally guided by and between the beam support vertical rollers 42.

Referring for example to FIG. 2, the protective element 16 defines substantially opposed protective element first and second ends 53 and 55. The protective element first and second ends 53 and 55 are closer to each other in the protective element retracted configuration than in the protective element extended configuration. In some embodiments of the invention, the protective element 16 includes a canvas 52, which is of a relatively sturdy construction. Canvas apertures 54 extends through the canvas 52 at the upper end thereof and at various longitudinal locations therealong.

Protective element supports 56 are secured to the protective element 16 and mounted through the slit 24. The protective element supports 56 have a portion thereof that is larger than a width of the slit 24 and that is mounted in the beam passageway 18. In the embodiment of the invention shown in FIG. 2, the protective element supports 56 are provided for supporting the canvas 52. As seen in FIG. 4, the protective element supports 56 each include at least one wheel 58 mounted in the beam support passageway 29. In the specific embodiment of the invention shown in the drawings, a pair of wheels 58 is mounted to a canvas mounting flange 60 so as to be rotatable relative thereto. The canvas mounting flange 60 also defines a canvas mounting flange aperture 62 opposed to the wheels 58.

The protective element supports 56 are inserted in the beam passageway 18. The wheels 58 are supported on the roller supporting surface 22 and rollable along the beam 12 inside the beam passageway 18. The canvas mounting flanges 60 extends through the slit 24 and protrude from the beam 12. A fastener, not shown in the drawings, extends through the canvas mounting flange aperture 62 and the canvas apertures 54 for mounting the canvas 52 to the protective element supports 56.

The protective element 16 is provided between the beam first end 15 and the beam support 14. The beam support 14 prevents movements of the protective element second end 55 towards the beam second end 17 beyond a predetermined location, for example beyond the beam support 14. In the embodiment of the invention shown in the drawings, this function is performed by the lower connecting plate 34 that blocks passage of the protective element supports 56 through the beam support 14.

In some embodiments of the invention, the protective element 16 is mounted to the beam 12 so that the protective element first end 53 and the beam first end 15 remain substantially fixed relative to each other when the protective element 16 is moved between the protective element extended and retracted configurations. For example, the canvas 52 is fixedly secured to the beam 12 adjacent the protective element first end 53 and the beam first end 15. In some embodiments of the invention, the protective element 16 is operatively coupled to the beam support 14 so that the protective element second end 55 and the beam support 14 remain substantially fixed relative to each other when the beam 12 is moved between the beam extended and retracted configurations. This may be achieved by attaching the beam support 14 and the protective element 16 to each other adjacent the protective element second end 55. However, in alternative embodiments of the invention, the protective element 16, beam support 14 and beam 12 are all movable relative to each other without any part of the protective element 16 remaining fixed relative to the beam 12, beam support 14 or both the beam 12 and beam support 14.

An end element 68 extends from the beam 12 substantially adjacent the beam first end 15. The end element 68 is for example substantially elongated and extends generally perpendicular to the beam 12, typically along substantially the whole vertical extent of the canvas 52, the protective element first end 53 being, in some embodiments, substantially adjacent the end element 68. In some embodiments of the invention, a handle 70 is provided on the end element 68 to facilitate movements of the beam 12 along the beam support 14 by an intended user.

In some embodiments of the invention, a proximity sensor 72 is secured to the end element 68. The proximity sensor 72 is operable in conjunction with another sensor, not shown, provided on a fixed structure, to indicate that the protective element 16 is extended, and that therefore the machinery is protected and can be operated. The proximity sensor 72 is therefore part of an interlock system couplable to the machinery. In some embodiments, when the protective elements 16 is in the protective element retracted configuration, the absence of signal from the proximity sensor 72 is used to block operation of machinery protected by the protective barrier 10. Such interlock systems are well known in the art and will therefore not be described in further details.

The protective element 16 is typically secured at one end thereof to the end element 68 or to any other adjacent structure that moves with the beam first end 15. The protective element 16 is also typically secured at the opposite end thereof to a fixed structure, that is fixed relative to the beam support 14.

In operation, moving the beam 12 along the beam support 14 extends and retracts the protective element 16 so that access is provided to elements located on the other side of the protective element 16. Advantageously, not only is the protective element 16 retracted by this movement of the beam 12, but the beam 12 is also simultaneously retracted, which provides unimpeded access to the machinery protected by the protective element 16.

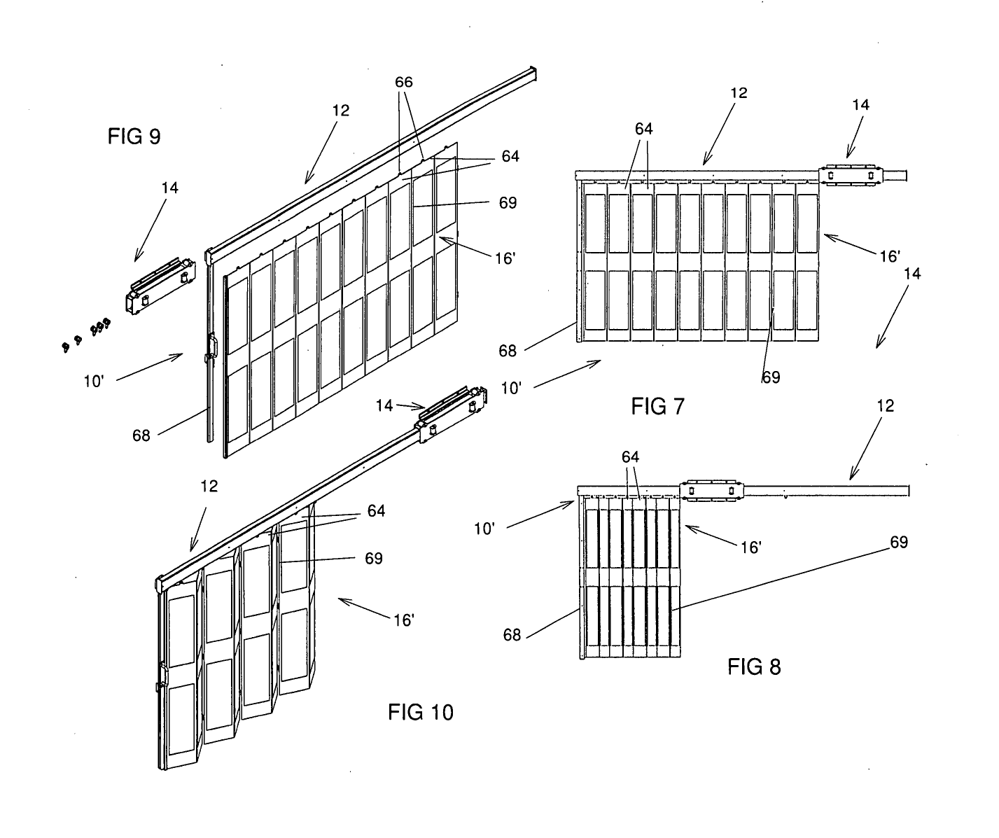

FIGS. 7 to 10 illustrates a protective barrier 10′ in accordance with an alternative embodiment of the present invention. Referring for example to FIG. 9, the protective barrier 10′ is similar to the protective barrier 10, except that a protective element 16′ part of the protective barrier 10′ does not include a canvas 52, but is is an accordion protective element 16′. The accordion protective element 16′ includes a series of parallel panels 64 extending along the beam 12 and serially hinged to each other, each panel 64 being elongated and extending generally perpendicular to the beam 12. Each of the panels 64 defines a panel aperture 66 extending adjacent the upper end thereof, typically in the middle of the panel 64. The panel aperture 66 is used in a similar manner to the canvas aperture 54 to secure the protective element 16′ to the beam 12. In some embodiments of the invention, the panels 64 are substantially rigid and provided with windows 69. The series of panels is foldable together. The folding process is shown in FIG. 10, in which some of the panels 64 have been omitted for clarity reasons.

In yet other embodiments of the invention, the protective element 16 includes any other suitable structure that is retractable while being sturdy enough to act as a barrier.

Although the present invention has been described hereinabove by way of preferred embodiments thereof, it can be modified, without departing from the spirit and nature of the subject invention as defined in the appended claims.

What is claimed is:

1. A protective barrier, said protective barrier comprising:
a substantially elongated beam defining substantially longitudinally opposed beam first and second ends;
a beam support supporting said beam, said beam being substantially longitudinally movable relative to said beam support between a beam extended configuration and a beam retracted configuration, said beam first end being closer to said beam support in said beam retracted configuration than in said beam extended configuration; and
a protective element mounted to said beam and configurable between a protective element extended configuration and a protective element retracted configuration, said protective element defining substantially opposed protective element first and second ends;
wherein said protective element extends along a larger portion of said beam in said protective element extended configuration than in said protective element retracted configuration so that said protective element first and second ends are closer to each other in said protective element retracted configuration than in said protective element extended configuration.

2. A protective barrier as defined in claim 1, wherein said protective element is provided between said beam first end and said beam support, said beam support preventing movements of said protective element second end towards said beam second end beyond a predetermined location.

3. A protective barrier as defined in claim 2, wherein said beam support prevents movements of said protective element second end towards said beam second end beyond said beam support.

4. A protective barrier as defined in claim 2, wherein said protective element is mounted to said beam so that said protective element first end and said beam first end remain substantially fixed relative to each other when said protective element is moved between said protective element extended and retracted configurations.

5. A protective barrier as defined in claim 4, wherein said protective element is operatively coupled to said beam support so that said protective element second end and said beam support remain substantially fixed relative to each other when said beam is moved between said beam extended and retracted configurations.

6. A protective barrier as defined in claim 1, wherein said beam support defines a beam support passageway, said beam being partially inserted in said beam support passageway.

7. A protective barrier as defined in claim 6, wherein said beam support is provided with beam support rollers protruding at least partially in said beam support passageway for guiding movements of said beam in said beam passageway.

8. A protective barrier as defined in claim 7, wherein said beam support rollers include beam support horizontal rollers at least partially supporting said beam.

9. A protective barrier as defined in claim 7, wherein said beam support rollers include beam support vertical rollers at least partially guiding lateral movements of said beam.

10. A protective barrier as defined in claim 1, wherein said beam defines a beam outer surface and a beam passageway both extending substantially longitudinally therealong, a substantially longitudinally extending slit extending between said beam outer surface and said beam passageway, said protective barrier further comprising protective element supports secured to said protective element and mounted through said slit, said protective element supports having a portion thereof that is larger than a width of said slit and mounted in said beam passageway.

11. A protective barrier as defined in claim 10, wherein said slit is provided on an underside of said beam so that said protective element is suspended from said beam.

12. A protective barrier as defined in claim 11, wherein said protective element supports each include at least one wheel rollable along said beam inside said beam passageway when mounted thereinto.

13. A protective barrier as defined in claim 1, further comprising an end element extending from said beam substantially adjacent said beam first end.

14. A protective barrier as defined in claim 13, wherein said end element is provided with a handle.

15. A protective barrier as defined in claim 13, wherein said protective element first end is substantially adjacent said end element.

16. A protective barrier as defined in claim 15, wherein said end element extends substantially perpendicular to said beam.

17. A protective barrier as defined in claim 1, wherein said protective element includes a canvas.

18. A protective barrier as defined in claim 1, wherein said protective element is an accordion protective element including a series of panels extending along said beam and serially hinged to each other, said series of panels being foldable together.

19. A protective barrier as defined in claim 1, further comprising a proximity sensor part of an interlock system couplable to a piece of machinery for preventing operation of said piece of machinery when said beam is moved away from said beam extended configuration.
